(19) United States
(12) Patent Application Publication
(10) Pub. No.: US 2014/0134506 A1
(43) Pub. Date: May 15, 2014

(54) Proton Exchange Membrane

(71) Applicant: Francis John Kub, Arnold, MD (US)

(72) Inventor: Francis John Kub, Arnold, MD (US)

(73) Assignee: Francis John Kub, Arnold, MD (US)

(21) Appl. No.: 14/073,853

(22) Filed: Nov. 6, 2013

Related U.S. Application Data
(60) Provisional application No. 61/722,818, filed on Nov. 6, 2012.

(51) Int. Cl. H01M 8/02

(52) U.S. Cl. CPC H01M 8/0291
USPC 429/413

(57) ABSTRACT

A proton exchange membrane with self-humidifying characteristics having proton conducing polymer nanofibers with hygroscopic characteristics and a second polymer impregnated into voids between the nanofibers to form a self-humidifying proton exchange membrane. Also disclosed is a proton exchange membrane having polymer or inorganic material nanofibers with hygroscopic characteristics and a proton conducting second polymer impregnated into voids between the nanofibers.

### CROSS-REFERENCE

This application is a Nonprovisional of and claims the benefit of priority under 35 U.S.C. §119 based on U.S. Provisional Patent Application No. 61/722,818 filed on Nov. 6, 2012, the entirety of which is hereby incorporated by reference into the present application.

### TECHNICAL FIELD

The present invention relates generally to proton exchange membranes and, more specifically, to self-humidifying proton exchange membranes.

### BACKGROUND

Fuel cells operate by oxidizing a fuel, such as hydrogen, on the surface of an anode. Electrons generated in this process are conducted along a catalyst support through the external circuit, while the generated protons travel through an electrically insulating separator, to the cathode where they combine with oxygen, as it is reduced, forming water. Fuel cells have the potential for excellent energy efficiency.

A membrane electrode assembly (MEA) is an assembled stack of proton exchange membrane (PEM), catalyst, gas diffusion layers, and electrode used in a fuel cell. The proton exchange membrane (PEM) is also known as a polymer electrolyte membrane or an electrolyte membrane. The PEM is sandwiched between two electrodes which have the catalyst embedded in them. The electrodes are electrically insulated from each other by the PEM. These two electrodes make up the anode and cathode, respectively. The electrodes are generally heat pressed onto the PEM. The PEM is proton permeable, but an electrical insulator barrier. This barrier allows the transport of the protons from the anode to the cathode through the membrane but forces the electrons to travel around a conductive path to the cathode.

The Nafion® perfluorosulfonic acid membrane has been extensively studied for use in hydrogen/oxygen and direct methanol proton-exchange membrane (PEM) fuel cells, but it readily dehydrates at elevated temperatures and low humidity, it is a poor methanol barrier, and its mechanical properties are suspect. The proton conductivity of Nafion® is assisted by water molecules, hence the proton conductivity is low at high temperature and low relative humidity.

Atomic layer deposition (ALD) utilizes sequential self-limiting surface reactions to deposit a thin film nearly one monolayer at a time. By controlling the number of self-limiting reactions taking place the resulting film thickness is carefully controlled. Molecular layer deposition has the advantages of precise control over the film thickness, conformal coating of substrates, high aspect ratio coating. Molecular layer deposition (MLD) deposits a single layer of organic molecules per cycle for organic films. Molecular layer deposition has the advantages of precise control over the film thickness, conformal coating of substrates, high aspect ratio coating.

Zhamu, Guo, and Jang describe a self-humidifying proton exchange membrane that uses non-oxide deliquescent material and a metal catalyst for self-humidification, A. Zhamu, J. Guo, and B. Jang, “Self-humidifying proton exchange membrane, membrane-electrode assembly, and fuel cell,” U.S. Pat. No. 7,993,791, Date of patent Aug. 9, 2011.

### SUMMARY

This summary is intended to introduce, in simplified form, a selection of concepts that are further described in the Detailed Description. This summary is not intended to identify key or essential features of the claimed subject matter, nor is it intended to be used as an aid in determining the scope of the claimed subject matter. Instead, it is merely presented as a brief overview of the subject matter described and claimed herein.

In an embodiments of the current disclosure, the electrolyte membrane has a central layer region having a central second proton conducting polymer reinforced with a nanofiber mat; wherein the nanofiber mat is made from nanofibers comprising a fiber material selected from polymers, composite polymer, hygroscopic nanostructures within nanofibers, catalyst nanostructures within the nanofiber, and metal oxide material: wherein the fiber material may have a proton conductivity that is less than the proton conductivity of the central second proton conducting polymer; wherein the nanofiber mat may include a hygroscopic material on the surface of the nanofiber, within the pores of the nanofibers, on exposed surfaces of the inorganic nanostructures within the nanofiber; wherein the nanofiber mat may include a catalyst material on the surface of the nanofiber, within the pores of the nanofibers, on exposed surfaces of the inorganic nanostructures within the nanofiber, on the surface of hygroscopic material; and have a anode side proton conducting polymer regions on the anode side of the central layer region, and cathode side proton conducting polymer layer regions on the cathode side of the central layer region. The anode side proton conducting polymer maybe substantially electrical nonconductive. The cathode side proton conducting polymer maybe substantially electrical nonconductive.

In some embodiments, the polymer nanofiber are formed using the techniques of electrospining. In some embodiments, the polymer nanofibers comprise proton conducting material. In some embodiments, the polymer nanofibers have mechanical strength. In some embodiments, the polymer nanofibers provide mechanical reinforcement to proton exchange membranes. In some embodiments, the polymer nanofibers provide mechanical reinforcement and proton conduction. In some embodiments, the polymer nanofibers. In some embodiments, the polymer nanofibers comprise polymer blends. In some embodiments, the electrospun polymer nanofibers nanofibers have polymer blends. In some embodiments, inorganic nanofibers are formed using the techniques of electrospinning and annealing. In some embodiments, the inorganic nanofibers are carbon nanofibers. In some embodiments, the inorganic nanofibers are metal oxide nanofibers. In some embodiments, the polymer nanofibers comprise inorganic nanostructures. In some embodiments, the polymer nanofibers comprise inorganic hygroscopic material nanostructures. In some embodiments, the polymer nanofiber comprise catalyst material nanostructures. In some embodiments, the polymer nanofibers comprise hygroscopic material nanostructures and catalyst nanostructures. In some embodiments, the polymer nanofibers comprise combined material nanostructures. In some embodiments, the nanofibers are nonwoven. In some embodiments, the electrospin nanofibers can be woven. In some embodiments, the nanofibers are aligned

In some embodiments, the nanofiber material or nanofiber material with hygroscopic material may be coated with metal catalyst material that has an electrical conductivity from one of the major faces of the nanofiber mat to the second face of the nanofiber mat. The anode side proton conducting polymer may be removed and the cathode side proton conducting polymer maybe substantially electrical nonconductive. This emodiment provides the hygroscopic material and catalyst material in the nanofiber mat can facilitate the generation and storage of water molecules near the anode to facilitate humidification of the electrolyte membrane and have a substantially electrically nonconductive cathode side proton conducting polymer to achieve a subtantially electric nonconductive electrolyte membrane.

In some embodiments, the method of the current disclosure may include a step of forming a hygroscopic material within the nanofibers in the nanofiber mat. In some embodiments, the method of the current disclosure may include a step of forming a catalyst material within the nanofibers in the nanofiber mat In some embodiments, the method of the current disclosure may include a step of forming a hygroscopic material and catalyst material within the nanofibers in the nanofiber mat. In some embodiments, the method of the current disclosure may include a step of forming a combination material within the nanofibers in the nanofiber mat

In some embodiments, the method of the current disclosure may include a step of depositing a hygroscopic material on the surface of the nanofibers, in pores in the nanofiber, and or surface of exposed inorganic nanostructures within the nanofibers in the nanofiber mat using the techniques of atomic layer deposition or molecular layer absorption. In some embodiments, the method of the current disclosure may include a step of depositing a nonvapor formed hygroscopic material on the surface of the nanofibers, in pores in the nanofiber, and or surface of exposed inorganic nanostructures within the nanofibers in the nanofiber mat.

In some embodiments, the method of the current disclosure may include a step of depositing a catalyst material on the surface of the nanofibers, in pores in the nanofiber, and or surface of exposed inorganic nanostructures within the nanofibers in the nanofiber mat using the techniques of atomic layer deposition. In some embodiments, the method of the current disclosure may include a step of depositing a catalyst material on the surface hygroscopic formed on the surface of the nanofibers, in pores in the nanofiber, and or surface of exposed inorganic nanostructures within the nanofibers using the techniques of atomic layer deposition. In some embodiments, the method of the current disclosure may include a step of depositing a nonvapor formed catalyst material on the surface of hygroscopic material formed on the surface of the nanofibers, in pores in the nanofiber, and or surface of exposed inorganic nanostructures within the nanofibers.

In some embodiments, the method of the current disclosure includes the step of impregnating a second proton conducting polymer into the reinforincing nanofiber mat. In some embodiments, the method of the current disclosure includes the step of thinning the electrolyte membrane using techniques that may include lapping, grinding, polishing, and combinations thereof.

Advantages for the embodiments include reinforcement of the electrolyte membrane, for higher mechanical strength, ability to operate at higher temperatures by the presence of hygroscopic material and optional catalyst material within the electrolyte membrane, a higher concentration of hygroscopic material and optional catalyst material near in the region of the electrolyte membrane near the anode which is typically dehydrated at high current density and high temperature, improved stability of electrolyte membrane in wet and dry stages, facilitates higher fuel cell operation temperatures, controlled water swelling, improved chemical resistance, reduced cost for catalyst material because the atomic layer depositing technique can deposit ultrathin layers of metal catalyst, reduced cross over of the hydrogen and oxygen because of the presence of catalyst material that will react the hydrogen and oxygen. The fuel cell containing electrolyte membranes of the present disclosure can be used in a higher temperature and/or lower-humidity environment.

### GLOSSARY

Hygroscopic material may include deliquescent materials

### BRIEF DESCRIPTION OF THE DRAWINGS

FIG. 1 is a schematic illustration of a membrane electrode assembly of the present disclosure in use with an external electrical circuit.

FIG. 2A is a schematic illustration showing electrospun polymer nanofibers with a random orientation with nanofiber to nanofiber connection at the nanofiber intersection region and optional melting and compression of the nanofiber mat, prior to impregnating with second proton conductive polymer.

FIG. 2B is a schematic illustration showing electrospun inorganic nanofibers with a random orientation with nanofiber to nanofiber connection at the nanofiber intersection region and optional melting and compression of the nanofiber mat, prior to impregnating with second proton conductive polymer

FIG. 3A is a schematic illustration of a polymer nanofiber coated with a hygroscopic material film.

FIG. 3B is a schematic illustration of a polymer nanofiber with inorganic nanostructures within the nanofiber coated is a hygroscopic material film that is also optionally sulfonated.

FIG. 3C is a schematic illustration of an inorganic metal oxide hygroscopic material nanofiber coated a hygroscopic material film that is also optionally sulfonated.

FIG. 3D is a schematic illustration of a polymer nanofiber coated with hygroscopic material nanostructures that are also optionally sulfonated.

FIG. 3E is a schematic illustration of a polymer nanofiber coated with catalyst material nanostructures that is also optionally sulfonated.

FIG. 3F is a schematic illustration of a polymer nanofiber coated with combination material nanostructures that are also optionally sulfonated.

FIG. 3G is a schematic illustration of a polymer nanofiber coated with a hygroscopic material film on the surface of the nanofiber that are optionally sulfonated and also coated with a metal catalyst film on the surface of the hygroscopic material.

FIG. 3H is a schematic illustration of a polymer nanofiber coated with a hygroscopic material film that is optionally sulfonated and with catalyst nanostructures on the surface of the hygroscopic material.

FIG. 4 is a schematic illustration of polymer nanofiber mat coated with hygroscopic material that is optionally sulfonated and with second proton conducting polymer impregnated into the reinforcing polymer nanofiber mat.

FIG. 5A is a schematic illustration of an electrolyte membrane showing a central layer region and two outer layer regions.

FIG. 5B is a schematic illustration of an electrolyte membrane similar to that shown in FIG. 5A, but having a nanofiber mat in the central layer region and anode side proton conducting polymere and cathode side proton conducting polymer.

FIG. 5C is a schematic illustration of an electrolyte membrane similar to that shown in FIG. 5B, but not an having the anode side proton conducting polymer material.

FIG. 5D is a schematic illustration of an electrolyte membrane similar to that shown in FIG. 5B, but not having both the anode side proton conducting polymer material and the cathode side proton conducting.

FIG. 5E is a schematic illustration of an electrolyte membrane similar to that shown in FIG. 5B, but not having the cathode side proton conducting polymer material.

FIG. 5F is a schematic illustration of an electrolyte membrane similar to that shown in FIG. 5B, but having a nanofiber mat in the central layer region with a nonuniform concentration profile of hygroscopic material, a nonuniform concentration profile of catalyst material, or a nonuniform concentration profile of combined material formed on the surface or within the nanofibers in the nanofiber mat.

FIG. 5G is a schematic illustration of an electrolyte membrane similar to that shown in FIG. 5C, but having a nanofiber mat in the central layer region with a nonuniform concentration profile of hygroscopic material, a nonuniform concentration profile of catalyst material, or a nonuniform concentration profile of combined material formed on the surface or within the nanofibers in the nanofiber mat.

FIG. 5H is a schematic illustration of an electrolyte membrane similar to that shown in FIG. 5D, but having a nanofiber mat in the central layer region with a nonuniform concentration profile of hygroscopic material, a nonuniform concentration profile of catalyst material, or a nonuniform concentration profile of combined material formed on the surface or within the nanofibers in the nanofiber mat.

FIG. 6 is a schematic illustration of proton conducting polymer nanofiber mat coated with hygroscopic material that is optionally sulfonated and with second support polymer impregnated into the proton conducting polymer nanofiber mat.

FIG. 7A is a schematic illustration of a proton conducting polymer nanofiber coated with a hygroscopic material film that is optionally sulfonated.

FIG. 7B is a schematic illustration of a proton conducting polymer nanofiber with inorganic nanostructures within the proton conducting polymer nanofiber that is coated with a hygroscopic material film that is also optionally sulfonated.

FIG. 7C is a schematic illustration of a proton conducting polymer nanofiber coated with hygroscopic material nanostructures that are also optionally sulfonated.

FIG. 7D is a schematic illustration of a proton conducting polymer nanofiber coated with catalyst nanostructures that are also optionally sulfonated.

FIG. 7E is a schematic illustration of a proton conducting polymer nanofiber coated with combination material nanostructures that are also optionally sulfonated.

FIG. 7F is a schematic illustration of a proton conducting polymer nanofiber coated with a catalyst material film on the surface of the nanofiber and a hygroscopic material film formed on the surface of the catalyst material film with the hygroscopic material film is optionally sulfonated.

FIG. 7G is a schematic illustration of a proton conducting polymer nanofiber with catalyst material nanostructures formed on the surface of a proton conducting polymer nanofiber with a hygroscopic material film that is optionally sulfonated and is deposited on the surface of the catalyst material nanostructures and the surface of the proton conducting polymer nanofiber.

FIG. 8 is a schematic illustration of proton conducting polymer nanofiber mat coated with catalyst material nanostructures and hygroscopic material on the surface of the proton conducting nanofibers with the hygroscopic material that is optionally sulfonated and with second support polymer impregnated into the proton conducting polymer nanofiber mat.

FIG. 9A is a schematic illustration of an electrolyte membrane showing a central layer region and two outer layer regions.

FIG. 9B is a schematic illustration of an electrolyte membrane similar to that shown in FIG. 9A, but having a proton conducting polymer nanofiber mat in the central layer region and anode side proton conducting polymere and cathode side proton conducting polymer.

FIG. 9C is a schematic illustration of an electrolyte membrane similar to that shown in FIG. 9B, but not an having the anode side proton conducting polymer material.

FIG. 9D is a schematic illustration of an electrolyte membrane similar to that shown in FIG. 9B, but not having both the anode side proton conducting polymer material and the cathode side proton conducting.

FIG. 9E is a schematic illustration of an electrolyte membrane similar to that shown in FIG. 9B, but not having the cathode side proton conducting polymer material.

FIG. 9F is a schematic illustration of an electrolyte membrane similar to that shown in FIG. 9B, but having a proton conducting polymer nanofiber mat in the central layer region with a nonuniform concentration profile of hygroscopic material, a nonuniform concentration profile of catalyst material, or a nonuniform concentration profile of combined material formed on the surface or within the nanofibers in the nanofiber mat.

FIG. 9G is a schematic illustration of an electrolyte membrane similar to that shown in FIG. 9C, but having a proton conducting polymer nanofiber mat in the central layer region with a nonuniform concentration profile of hygroscopic material, a nonuniform concentration profile of catalyst material, or a nonuniform concentration profile of combined material formed on the surface or within the proton conducting polymer nanofibers in the proton conducting polymer nanofiber mat.

FIG. 9H is a schematic illustration of an electrolyte membrane similar to that shown in FIG. 9D, but having a proton conducting polymer nanofiber mat in the central layer region with a nonuniform concentration profile of hygroscopic material, a nonuniform concentration profile of catalyst material, or a nonuniform concentration profile of combined material formed on the surface or within the proton conducting polymer nanofibers in the proton conducting polymer nanofiber mat.

### DETAILED DESCRIPTION

The aspects and features of the present invention summarized above can be embodied in various forms. The following description shows, by way of illustration, combinations and configurations in which the aspects and features can be put into practice. It is understood that the described aspects, features, and/or embodiments are merely examples, and that one skilled in the art may utilize other aspects, features, and/or embodiments or make structural and functional modifications without departing from the scope of the present disclosure.

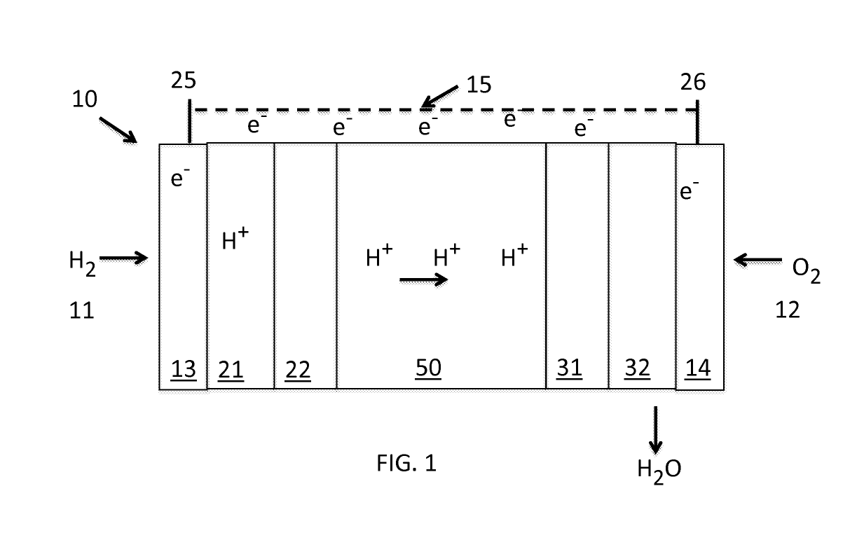

FIG. 1 is an illustration of a membrane electrode assembly (MEA). In some embodiments, the present disclosure includes a membrane electrode and fuel cell that comprise a disclosed electrolyte membrane. A fuel cell as shown includes gaseous reactants as fuel source (11) and an oxidizer source (12). These gasesous reactants diffuse through flow field/current collector plate 13 and 14, respectively, to an anode backing layer (an oxidizing electrode) 21 and a cathode backing layer (a reducing electrode) 32. Anode connection 25 and cathode connection 26 are used to interconnect with an exernal circuit 15 or with other fuel cell assemblies. Thus, an embodiment of the present disclosure is a fuel cell having an membrane electrode assembly (FIG. 1) comprising a electrolyte membrane 50 with two primary surfaces, an anode catalyst layer 22, a cathode catalyst layer 31 each with an inner surface attached to or integral with one of the two primary surface of the electrolyte membrane 50, an anode backing layer 21 attached to the outer surface of the anode catalyst layer 22, a cathode backing layer 32 attached to the outer surface of the cathode catalyst layer 31 and two respective flow field/current collector plate 13 and 14 pressed against the outer surface of the backing layers. Inside the anode current colector current collector/flow field plate has flow channels to admit air or oxygen and to exit water and unused air. The electrolyte membrane 50, the anode catalyst layer 22 and the cathode catalyste layer 31. In this fuel cell, at least one of the electrolyte membrane comprises a desired amount of hygroscopie material and optional metal catalyst material, which serves to self-moisturize the membrane layer.

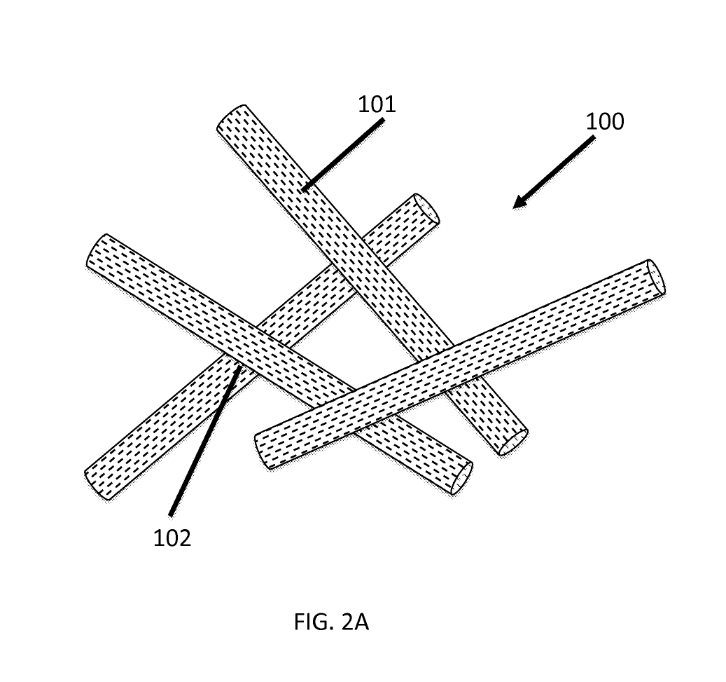

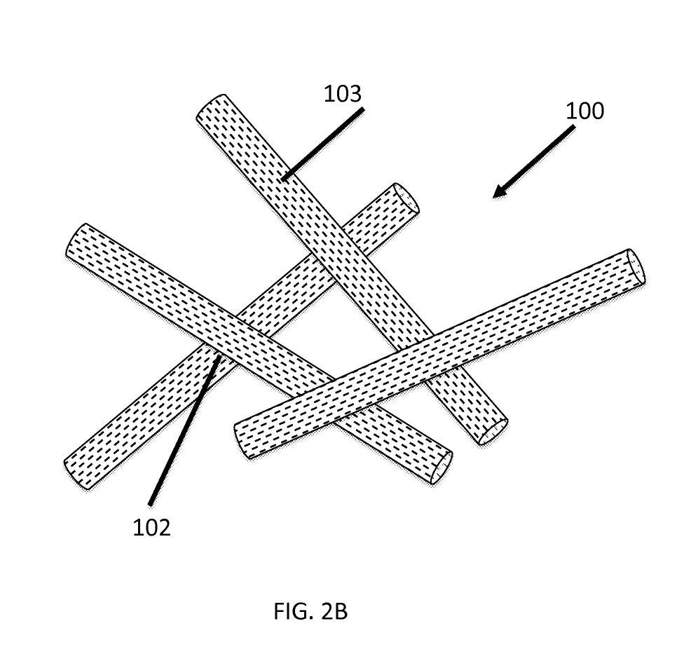

FIG. 2A is an illustration of a nanofiber mat 100 that comprise a nonwoven web of polymer nanofibers 101. The polymer nanofibers 101 can overlap at nanofiber to nanofiber insecting region 102. Additional process steps that can optionally be performed on the nanofiber mat are annealing the polymer reinforcing nanofiber mat during which time intersecting nanofibers are bonded to one another at cross points or overlaps 102. Additional optional process step include the process of mechanically compacting the reinforcing nanofiber mats to increase the volume density of nanofibers. The nanofibers with typical have a diameter in the range of about 30 nm to about 1000 nanometers. The polymer nanofiber 101 can include, but not be limited to, polyacrylonitrile (PAN) polymer, polyvinylidene difluoride (PVDF), Poly (ether sulfones) (PES), Polybenzimidazole (PBI), Polybenzimidazole (PPO), polyethersulfone (PES), as well as blends and combination of these polymers.

FIG. 2B is an illustration of a nanofiber mat 100 that comprise a nonwoven web of inorganic nanofibers 103. The inorganic nanofibers 103 can overlap at nanofiber to nanofiber insecting region 102

The nanofiber 101 may have pores within the nanofibers. The nanofiber may have inorganic nanostructures 105 within the nanofiber such as inorganic hygroscopic material nanostructures, inorganic catalyst material nanostructures, inorganic combined material nanostructures, inorganic proton conducting nanostructures, inorganic nanostructures with proton conducting and hygroscopic characteristic into a polymer and inorganic combined material within the nanofiber. Inorganic hygroscopic nanostructures within the nanofibers may include silica, SiO2, metal oxide, ZrO2, Al2O3, TiO2, Zr(HPO₄)₂, RuO2, CaO, solid inorganic proton conductors such as zirconium phosphate, cesium phosphate and combinations thereof. The inorganic catalyst nanostructures may include but not be limited to platinum, ruthenium, and combinations thereof.

The nanofiber may comprise inorganic nanofiber 103 formed of inorganic material such as metal oxide material or carbon material. The materials that comprise the metal oxide nanofibers 103 may be include titanium oxide, tin oxide, and other metal oxide material known to those of ordinary skill in the art. The metal oxide nanofibers can have hygroscopic properties. For the case that a carbon material is used as the nanofiber material, a electric nonconductive proton conducting polymer 210 or 220 should be within the electrolyte membrane to achieve a substantially electrical nonconductive electrolyte membrante 50.

The nanofibers 101 within the nanofiber mat 100 may comprise hygroscopic material, catalyst material, and combination material on or within the nanofibers. The combination material comprises a combination of hygroscopic material and catalyst material. The techniques of forming hygroscopic material, catalyst material, and combination material on or within the nanofibers include the stops of depositing, growing, forming, or adhering hygroscopic material, catalyst material, or a combination material on or within the nanofibers.

In some embodiments it may be desirable to activate/functionalize the surface of the nanofibers 101, the surface of pores within the nanofiber, and optionally the surfaces of exposed nanoparticles 105 that are within the nanofiber prior to depositing, growing, forming, or adhering hygroscopic material, catalyst material, or a combination material. The activation/functionaliztion process on the surface of the nanofibers 101 aids in the nucleation of molecule absorption of on the surface of the nanofiber during growth processes for hygroscopic material or catalyst material by techniques such as atomic layer deposition or molecular layer deposition. In addition, the activation/function process aids in the adhesion of hygroscopic material nanostructures, catalyst material nanostructures, or a combination material comprising hygroscopic material nanostructures and catalyst material. Techniques that may be used to activated/functionalize the surface of the nanofibers and exposed surface in pores in the nanofiber in the reinforcing nanofiber mat may include plasma treatment, corona treatment, fluid functionaliztion, gas phase functionalization, corona treatment, and combinations thereof.

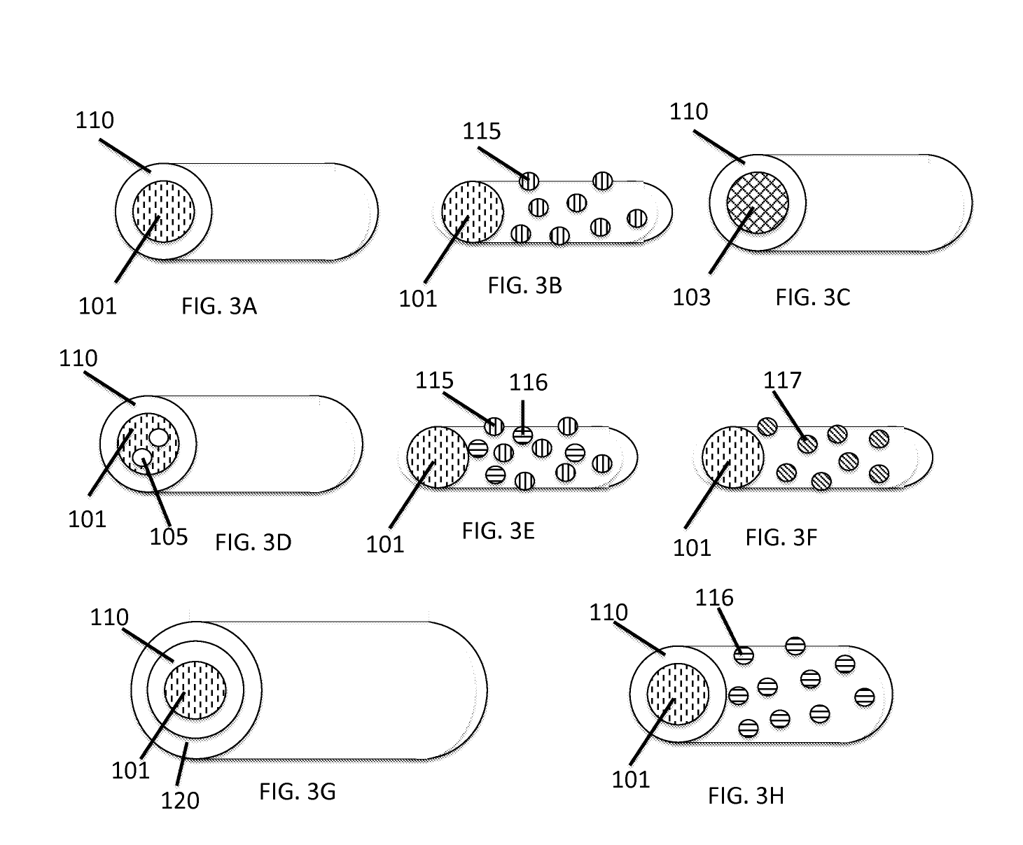

The hygroscopic material may comprise a hygroscopic material film or hygroscopic material nanostructures deposited on the surface of the nanofiber, within pores in the nanofibers, and on exposed surfaces of inorganic nanoparticles within the nanofiber. FIG. 3 is an illustration of hygroscopic material, catalyst material, or combination material formed on or within nanofibers. FIG. 3A is an illustration of a hygroscopic material film 110 on the surface of a polymer nanofiber 101. FIG. 3B is an illustration of hygroscopic material nanostructures 115 on the surface of polymer nanofibers 101. FIG. 3C is an illustration of a hygroscopic material film 110 on the surface of an inorganic nanofiber 103. The inorganic nanofiber material may include metal oxide material, silicon oxide material, catalyst material, and combinations thereof. The inoganic material may have hygroscopic characteristics and may have catalysis nanostructures within the inorganic nanofiber material. FIG. 3D is an illustration of a hygroscopic material film on the surface of polymer nanofiber 101 having inorganic nanostructures 105 within the polymer nanofiber. FIG. 3E is an illustration of hygroscopic material nanostructures and catalyst material nanostructures on the surface of a polymer nanofiber 101. FIG. 3F is illustration of combination material nanostructures 117 on the surface of the polymer nanofiber 101. FIG. 3G is an illustration of a hygroscopic material film 110 on the surface of a polymer nanofiber 101 and a catalyst material film 120 on the surface of the hygroscopic material. FIG. 3H is an illustration of hygroscopic material nanostructures 116 on the surface of a hygroscopic material film on the surface on the surface of a polymer nanofiber 101.

The hygroscopic material film 110 may be deposited by such techniques as atomic layer deposition (ALD) or moleculator layer deposition (MLD). The ALD and MLD techniques deposit material using vapor deposition approaches. The hygroscopic material deposited using ALD or MLD can perform the function of self-humidifying an electrolyte membrane 50 for a fuel cell. The ALD film or nanostructure with hygroscopic characteristics can comprise materials such as SiOH in a silicon oxide film, silica, fumed silica, ozone deposited silicon oxide film, titanium oxide, zirconium oxide, lanthanum oxide, gadolinium oxide film, zirconium phosphate, calcium oxide, tin oxide, hydrated tin oxide (SnO2.nH2O), sulfated zirconia (SiO2-SZ), polymer, nylon, platinum particles on SiO2, platinum particles on sulfonated SiO2, or other hygroscopic or sulfonated materials, and combination thereof.

Atomic layer deposition utilizes sequential self-limiting surface reactions to deposit a thin film nearly one monolayer at a time. By controlling the number of self-limiting reactions taking place the resulting film thickness is carefully controlled. The film deposited by ALD will typically be amorphous but can be crystalline. The ALD film can be deposited on the surface of the nanofiber and can also be deposited on the surface of pores within the polymer nanofiber. The ALD film can increase the mechanical strength of the polymer nanofiber 101.

The ALD or MLD deposited hygroscopic material can have a different percentage of coverage of the nanofiber, pores within the nanofiber, or exposed surface of inorganic nanoparticles within the nanofibers. The deposited hygroscopic material film 110 can have 100% coverage of the nanofiber, pores with the nanofiber, or exposed surface of inorganic nanoparticles within the nanofiber. The 100% coverage corresponds to a pinhole free film. The percentage of hygroscopic material coverage of the nanofiber can depend on the degree of percentage of nucleation sites on the surface of the nanofiber. The nucleation site function as the initial bonding sites for ADL or MLD precursors on the surface of the nanofibers. Pinholes in the hydroscopic material film can results from incomplete activation/functionalization of the nanofiber surface. Also, it is typically more difficult to nucleate ALD or MLD precursors on hydrophobic surfaces then on hydrophilic surface. The hydrophobic surface can be converted to a hydrophilic surface by functionalization techniques that may include plasma functionalization, gas phase functionalization, fluidic functionalization, and combinations thereof. Pinhole free hygroscopic films can result for a high degree of creation of nucleation sites on the surface of the nanofiber surface. A hygroscopic film with pinholes or nanostructures can result for a lower degree of creation of nucleation sites on the surface of the nanofiber, within pores in the nanofiber or on surfaces of exposed inorganic particles within the fibers. A high percentage of coverage of hygroscopic material on the surface of the nanofibers, within pores, or on exposed surface of inorganic nanoparticles within the nanofiber is desirable to provide hygroscopic material for absorption of water molecules for self-humidifying the electrolyte membrane 50.

The atomic layer deposition approach can include plasma ALD, oxygen plasma assisted ALD, plasma enhanced ALD, plasma enabled, remote plasma ALD, ozone assisted ALD, ozone based ALD, thermal ALD, energy enhanced ALD, H2 plasma ALD, and roll-to-roll ALD, and other approached known to those of ordinary skill in the art.

The deposition of an ALD film on nanofiber and within pores in the nanofiber can modify the mechanical strength of the reinforcing nanofiber mat. The deposition of an ALD film on nanofiber and within pores in the nanofiber will typically increase the mechanical strength of the fiber mat 100.

The hygroscopic material may also comprise non-vapor formed hygroscopic material nanostructures 115 deposited or grown on the surface of the nanofibers, deposited or grown within pores in the nanofiber, or formed within the nanofibers during the process of forming the nanofibers 101 or 103. The non-vapor formed hygroscopic nanostructures 115 can include, but not be limited to nanostructures of silica, SiO2, metal oxide, ZrO2, Al2O3, TiO2, Zr(HPO₄)₂, RuO2, CaO, and combinations thereof.

Techniques that can be used to deposit non-vapor formed hygroscopic nanostructures 115 on the surface of the film and optionally within pores in the nanofiber, and on exposed surfaces of nanoparticles 105 within the nanfiber may include electrochemical growth of nanoparticles, hydrothermal growth of nanoparticles, fluid immersion, aerosol spraying of nanoparticles, vacuum sraying of nanoparticles, aerosol vacuum spraying of nanoparticles, and combinations thereof.

The hygroscopic material, optionally the catalyst material, nanofiber surface, pore surfaces, and nanoparticles within the nanofiber 101 can be sulfonated. One advantage of sulfonating the hygroscopic material, optionally the catalyst material, nanofiber surface, pore surfaces, and nanoparticles within the nanofiber is to provide additional sites for proton conductivity. Techniques for sulfonating the hygroscopic material, catalyst material, nanofiber surface, pore surfaces, and nanoparticles within the nanofiber include but are not limited to soaking in a solutions having concentrated H2SO4 with a concentration of about 98 percent at 80 C for about a hour, exposure to fuming sulfuric acid, soaking in chlorosulfonic acid, and combinations thereof.

The catalyst material may comprise material film 120 such as platinum, rutherium, platinum-rutherium deposited on the surface of the nanofiber, within pores in the nanofibers, or on exposed surface of inorganic particles within the nanofiber. The catalyst material can catalyze the recombination of crossover hydrogen with crossover oxygen to generate water molecules within the electrolyte membrane.

The catalyst material can be a catalyst material film 120 or catalyst material nanostructures 115. The catalyst material film can be deposited by techniques such as atomic layer deposition. An advantage of the atomic layer deposition approach for depositing the catalyst material is that an ultrathin layer of catalyst material can be deposited. Since platinum and rutherium can have significant cost, it can be advantageous to deposit small amounts of the platinum or rutherium metal. Atomic layer deposited films can be in the range of about 0.3 nm to about 20 nm, and can be in the range of about 0.3 nm to 50 nm. The deposited catalyst metal films may be a continuous film with electric conductivity or discontinuous film with no electric conductivity or small levels of electrical conductivity. The degree of creation of nucleation sites on the surface of the nanofiber or the degree of the creation of nucleation sites on the surface of hygroscopic material on the surface of the nanofibers can affect whether the catalyst material film is continuous or discontinuous. The electrolyte membrane should be substantially electrical nonconductive. For the case that a continuous metal film of catalysis material is deposited on the surface of the nanofiber, a electric nonconductive proton conducting polymer 210 or 220 should be with in the electrolyte membrane to achieve a substantially electrical nonconductive electrolyte membrante 50.

The catalyst material may also include nonvapor formed metal nanostructures 115 deposited or grown on the surface or the nanofibers, deposited or grown within pores in the nanofibers, or formed within the nanofibers during the process of forming the nanofibers. The catalyst material may comprise deposited films grown by such techniques as atomic layer deposition. The catalyst material can facilitate the recombination of crossover hydrogen with crossover oxygen to generate water molecules within the electrolyte membrane 50.

The catalyst nanostructures that catalyze the recombination of crossover hydrogen with crossover oxygen to generate water molecules within the electrolyte membrane 50 include platinum nanoparticles, rutherium nanoparticles, and combinations thereof.

In some embodiments, the catalyst materials is deposited or grown or adhered to the nanofiber mat 100 or the hygroscopic material on the nanofiber mat so that catalyst material does not exhibit the property of having some or moderate electrical conductivity from the first side of the electrolyte membrane to the second side of the electrolyte membrane. In some embodiments, the catalyst material formed by deposition and ALD film or nanostructure may not form a continuous film that has performance limiting electrical conductivity. The catalyst can be a continuous film with electrical conductivity if a film, sheet material with insulating characteristics is between the anode and the electrolyte membrane or between the electrolyte membrane and the cathode.

The combination materials may comprise coreshell nanostructures with catalyst material cores and hygroscopic material shells, hygroscopic material cores and catalyst material shell, platinum core and SiO2 shell, SiO2 core and platinum shell, bifunctional nanoparticles such as RuO2.xH2O that can conduct are both hygroscopic and able to conduct protons, and other metal nanostructures having both hygroscopic and catalyst characteristics. The combination material may comprise an atomic layer deposited laminate material having layers of hygroscopic material and catalyst material. An example of a atomic layer deposited combination material is a laminate formed of one or more alternating pairs of silicon oxide film and platinum film. For example, the laminate may be stacked pairs of 1 nm thick silicon oxide film and a 1 nm thick platinum film The combination material can catalyze the recombination of crossover hydrogen with crossover oxygen to generate water molecules within the electrolyte membrane. The combination material can also reduce the amount of crossover oxygen and cross over hydrogen that is able to diffuse through the electrolyte membrane.

In some embodiments, the hygroscopic material is first coated or deposit on the reinforcing nanofiber mat 100 and a catalyst material or combination mateirs is deposited on the surface of the hygroscopic material. In some embodiments, the catalyst material or can be deposited on the surface of the reinforcing nanofiber mat

The hygroscopic material may have a substantially uniform concentration or a nonuniform concentration profile in the direction from the within the nanofiber mat 100. The catalyst material may have a substantially uniform second concentration or a nonuniform concentration profile in the direction from the within the nanofiber mat 100. The combination material may have a substantially uniform concentration or a nonuniform concentration profile in the direction from the within the nanofiber mat 100. The concentration and concentration profile of the hygroscopic material can be different then the concentration and concentration profile of the catalyst material or the combination material. The concentration of the hygroscopic material on or within the nanofiber mat will typically be higher near the side of the nanofiber mat in the central region 200 near the anode 230 then the region of the fiber mat in the central region closer to the cathode 240. The concentration of hygroscopic material may have a monotonic decreasing concentration from the anode side of the fiber mat to the cathode side of the fiber mat, may have a step concentration profile with typically a higher concentration near the anode side of the fiber mat, or may have other concentration profiles. The concentration of the catalyst material can have a monotonic decreasing concentration profile from the anode side of the fiber mat to the cathode side of the fiber mat, may have a step concentration profile with typically a higher concentration near the anode side of the fiber mat, or may have other concentration profiles. The concentration of the combination material can have a concentration profile in the direction from the anode side of the fiber mat to the cathode side of the fiber mat, may have a step concentration profile with typically a higher concentration near the anode side of the fiber mat, or may have other concentration profiles. The concentration of the catalyst material or the combination material will also typically be higher near in the region of the electrolyte membrane 50 near the anode then the region of the electrolyte membrane 50 closer to the cathode. The advantage of having a higher concentration of hygroscopic material and catalyst material near the anode is that the region of the membrane near the anode can be dehydrated at higher current operation or higher temperature. One reason for the dehydration near the anode is osmotic drag which tends to drag water molecules in a direction from the anode to the cathode. At higher currents, there is a higher osmotic drag of water molecules and thus a greater tendency for the region of the electrolyte membrane near the anode to be dehydrated.

The hygroscopic material, the catalyst material, and the combination material have a substantially uniform concentration or a nonuniform concentration within the nanofiber mat 100. Techniques that can form a nonuniform concentration of hygroscopic material, catalyst material, or combination material within the nanofiber mat 100 include atomic layer deposition with ALD precursor exposure from one side of the nanofiber mat, spray coating one side of the nanofiber ma with hygroscopic material nanostructures, partically dipping the nanofiber mat in a solution having hygroscopic material nanostructures, and other techniques known to those of ordinary skill in the art.

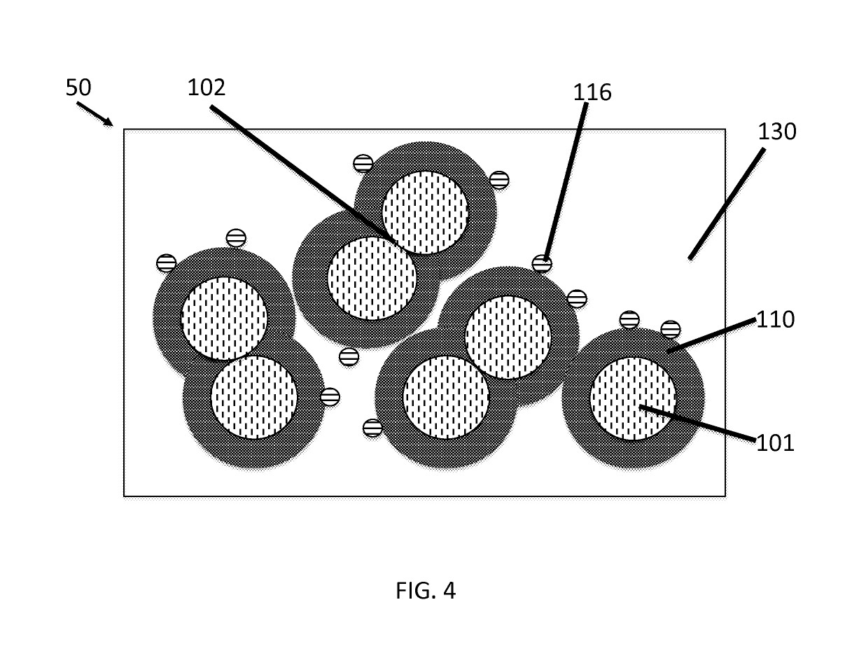

FIG. 4 is illustration of an electrolyte membrane 50 with second proton conducting polymer 130 impregnated into nanofiber mat 100 with hygroscopic material film 110 on the surface of the nanofiber 101. The nanofibers 101 can overlap at nanofiber to nanofiber insecting region 102. Additional process steps that can optionally be performed on the nanofiber mat are annealing the polymer reinforcing nanofiber mat during which time intersecting nanofibers are bonded to one another at cross points or overlaps 102. Additional optional process step include the process of mechanically compacting the reinforcing nanofiber mats to increase the volume density of nanofibers. The second proton conducting polymer is impregnated (imbibing) into the nanofiber mat. Techniques that can be used to impregnate the nanofiber mat 100 with a second proton conducting polymer include spray coating one surface of the nanofiber mat with a conducting polymer and pull a vacuum from the second side of the nanofiber mat, bar coating, brush coating, and the like.

The second proton conducting polymer 130 that may be impregnated into the nanofiber mat 100 of the present disclosure includes, but is not limited to, sulfonated poly (arylene ether sulfone) (sPAES), sulfonated polyhedral olgomeric silsesquioxane (sPOSS), perfluorosulfonic acid (PFSA), sulfonated polyetheretherketone (SPEEK), sulfonated polyimide, polystyrene sulfonic acid (PSSA), polyvinylsulfonic acid (PVS), sulfonated polyethersulfone (SPES), sulfonated polystyrene (SPS), sulfonated polysulfone (SPSU), and copolymers, blends, and mixtures thereof.

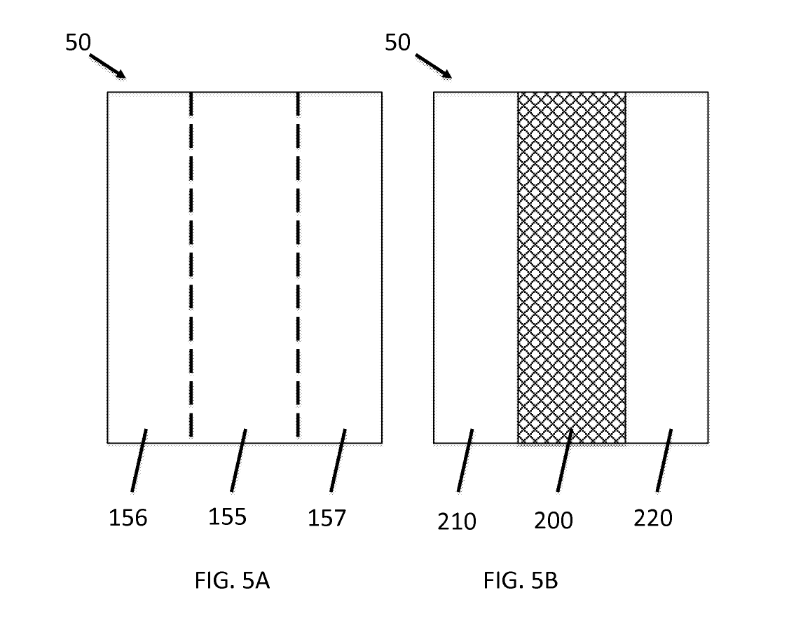

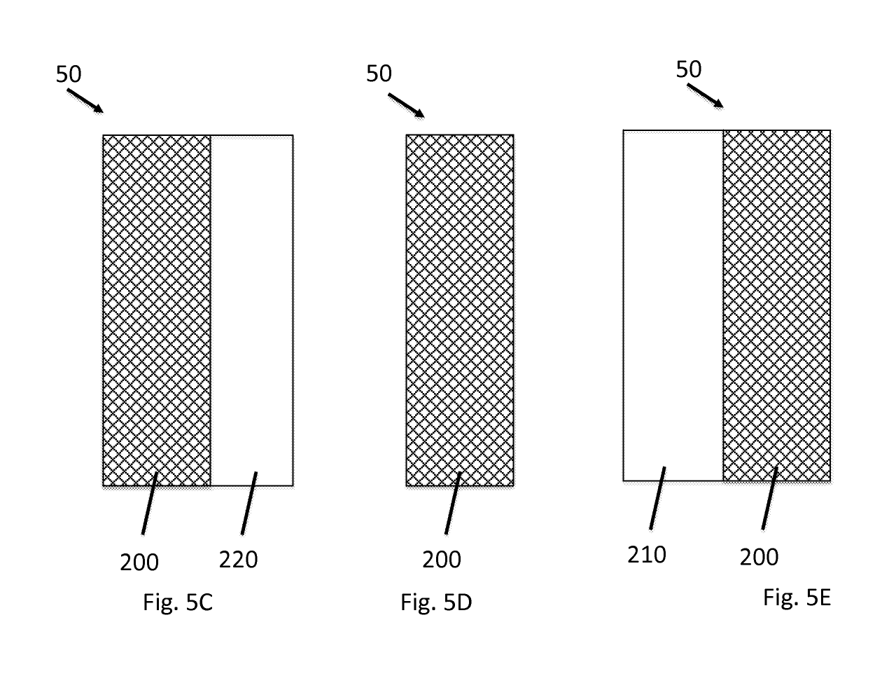

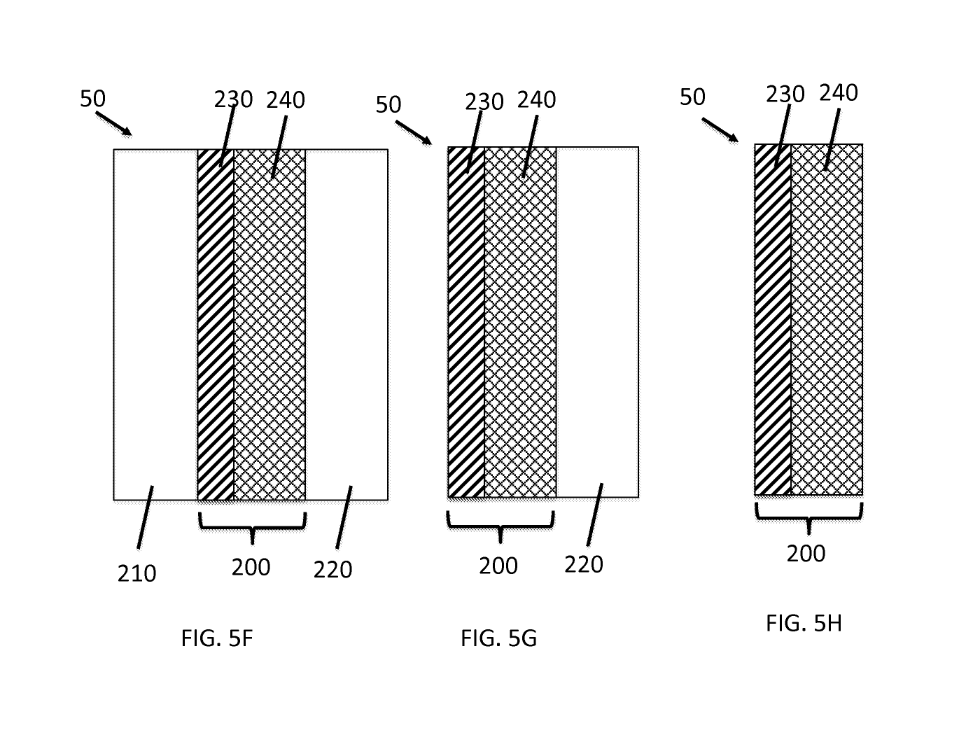

FIG. 5A is an illustration of an electrolyte membrane with an anode side region 156, a central region 155, and a cathode side region 157.

FIG. 5B is an illustration of an electrolyte membrane with anode side proton conducting polymer 210, central region 200 with second proton conducting polymer 130 impregnated into the voids in nanofiber mat 100, and a cathode side proton conducting polymer 220. The nanofibers 101 or 103 may have hygroscopic characteristics, may have catalyst material with catalyst characteristics, and may have combined material with hygroscopic characteristics and catalyst characteristics. The anode side proton conducting polymer 210 and may have hygroscopic material nanostructures dispersed within the anode side proton conducting polymer 210 with uniform or nonuniform concentration profile. The cathode side proton conducting polymer 220 may have hygroscopic material nanostructures dispersed within the cathode side proton conducting polymer 220 with uniform or nonuniform concentration profile. The anode side proton conducting polymer 210 may have hygroscopic material nanostructures and catalyst material nanostructures dispersed within the anode side proton conducting polymer 210 with uniform or nonuniform concentration profile. The cathode side proton conducting polymer 220 may have hygroscopic material nanostructures and catalyst material nanostructures dispersed within the cathode side proton conducting polymer 220 with uniform or nonuniform concentration profile. The anode side proton conducting polymer 210 may have combination material nanostructures dispersed within the anode side proton conducting polymer 210 with uniform or nonuniform concentration profile. The cathode side proton conducting polymer 220 may have combination material nanostructures dispersed within the cathode side proton conducting polymer 220 with uniform or nonuniform concentration profile.

FIG. 5C is an illustration of an electrolyte membrane with central region 200 with second proton conducting polymer 130 impregnated into the voids in nanofiber mat 100 and a cathode side proton conducting polymer 220. The nanofibers 101 or 103 may have hygroscopic characteristics, may have catalyst material with catalyst characteristics, and may have combined material with hygroscopic characteristics and catalyst characteristics. The embodiment shown in FIG. 5C can be implemented by coating a central region 200 with cathode side proton conducting polymer 220. Alternately, the embodiment shown in FIG. 5C can be implemented by removing the anode side conducting polymer 210 using techniques that may include lapping, grinding, polishing, and combinations thereof. It can be desirable tht catode side proton conducting polymer has substantially electrical nonconductive characteristics if the material in the central region 200 has electrical conductive characteristics.

FIG. 5D is an illustration of an electrolyte membrane with central region 200 with second proton conducting polymer 130 impregnated into the voids in nanofiber mat 100. The nanofibers 101 or 103 may have hygroscopic characteristics, may have catalyst material with catalyst characteristics, and may have combined material with hygroscopic characteristics and catalyst characteristics. The embodiment shown in FIG. 5D can be implemented by removing the anode side proton conducting polymer 210 and the cathode side proton conducting polymer using techniques that may include lapping, grinding, polishing, and combinations thereof.

FIG. 5E is an illustration of an electrolyte membrane with central region 200 with second proton conducting polymer 130 impregnated into the voids in nanofiber mat 100, and an anode side proton conducting polymer 220. The nanofibers 101 or 103 may have hygroscopic characteristics, may have catalyst material with catalyst characteristics, and may have combined material with hygroscopic characteristics and catalyst characteristics. The embodiment shown in FIG. 5E can be implemented by coating a central region 200 with second proton conducting polymer 130 impregnated into the voids in nanofiber mat 100. Alternately, the embodiment shown in FIG. 5E can be implemented by removing the cathode side conducting polymer 220 of the embodiment shown in FIG. 5B using techniques that may include lapping, grinding, polishing, and combinations thereof. It can be desirable that the anode side proton conducting polymer has substantially electrical nonconductive characteristics if the material in the central region 200 has electrical conductive characteristics.

FIG. 5F is an illustration of an electrolyte membrane with anode side proton conducting polymer 210; a central region 200 with second proton conducting polymer 130 impregnated into the voids in nanofiber mat 100, and a cathode side proton conducting polymer 220. The nanofibers 101 or 103 may have hygroscopic characteristics, may have catalyst material with catalyst characteristics, and may have combined material with hygroscopic characteristics and catalyst characteristics. The concentration of the hygroscopic material on or within the nanofiber mat will typically be higher near the side of the nanofiber mat in the central region 200 near the anode 230 then the region of the fiber mat in the central region closer to the cathode 240. The concentration of hygroscopic material may have a monotonic decreasing concentration from the anode side of the fiber mat to the cathode side of the fiber mat, may have a step concentration profile with typically a higher concentration near the anode side of the fiber mat, or may have other concentration profiles. The catalyst material may have nonuniform concentration profile and the combined material may have nonuniform concentration profile. The hygroscopic material and catalyst material may have different concentration profiles.

FIG. 5G is an illustration of an electrolyte membrane with a central region 200 with second proton conducting polymer 130 impregnated into the voids in nanofiber mat 100 with the nanofibers having nonuniform concentration profile of material having hygroscopic characteristics, optionally having catalyst material with catalyst characteristics, and optionally having combined material characteristics; and a cathode side proton conducting polymer 220. The embodiment in FIG. 5G is similar to the embodiment in FIG. 5F with the anode side proton conducting polymer 210 removed.

FIG. 5H is an illustration of an electrolyte membrane with a central region 200 with second proton conducting polymer 130 impregnated into the voids in nanofiber mat 100 with the nanofibers having nonuniform concentration profile of material having hygroscopic characteristics, optionally having catalyst material with catalyst characteristics, and optionally having combined material characteristics; and a cathode side proton conducting polymer 220. The embodiment in FIG. 5G is similar to the embodiment in FIG. 5F without the anode side proton conducting 210 polymer and the cathode side proton conducting polymer 220.

FIG. 6 is an illustration of a proton conducting nanofiber mat 300 that comprise a nonwoven web of proton conducting polymer nanofibers 301. The proton conducting polymer nanofibers 301 can overlap at nanofiber to nanofiber insecting region 202. Additional process steps that can optionally be performed on the nanofiber mat are annealing the polymer reinforcing nanofiber mat during which time intersecting nanofibers are bonded to one another at cross points or overlaps 302. Additional optional process step include the process of mechanically compacting the reinforcing nanofiber mats to increase the volume density of nanofibers. The nanofibers with typical have a diameter in the range of about 30 nm to about 1000 nanometers. The proton conducting polymer nanofiber 301 material can include but not be limited to sulfonated poly (arylene ether sulfone) (sPAES), sulfonated polyhedral olgomeric silsesquioxane (sPOSS), perfluorosulfonic acid (PFSA), sulfonated polybenzimidazoles, sulfonated polyetheretherketone (SPEEK), and copolymers, blends, and mixtures thereof.

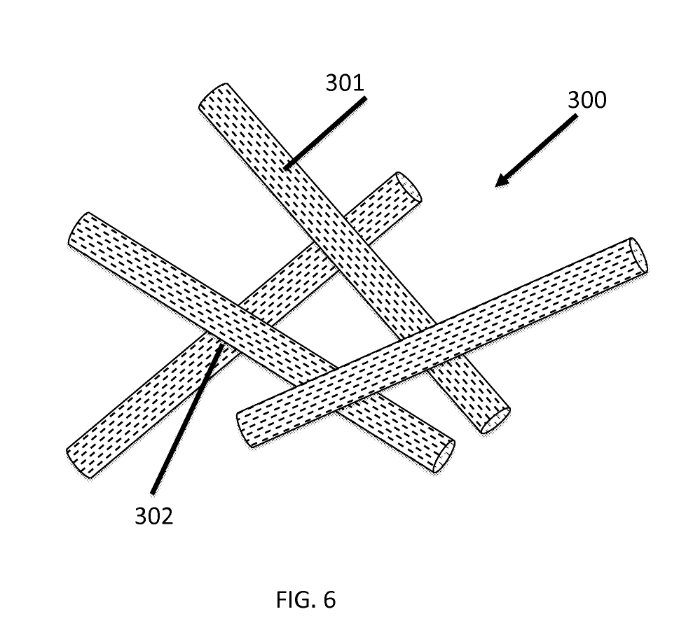

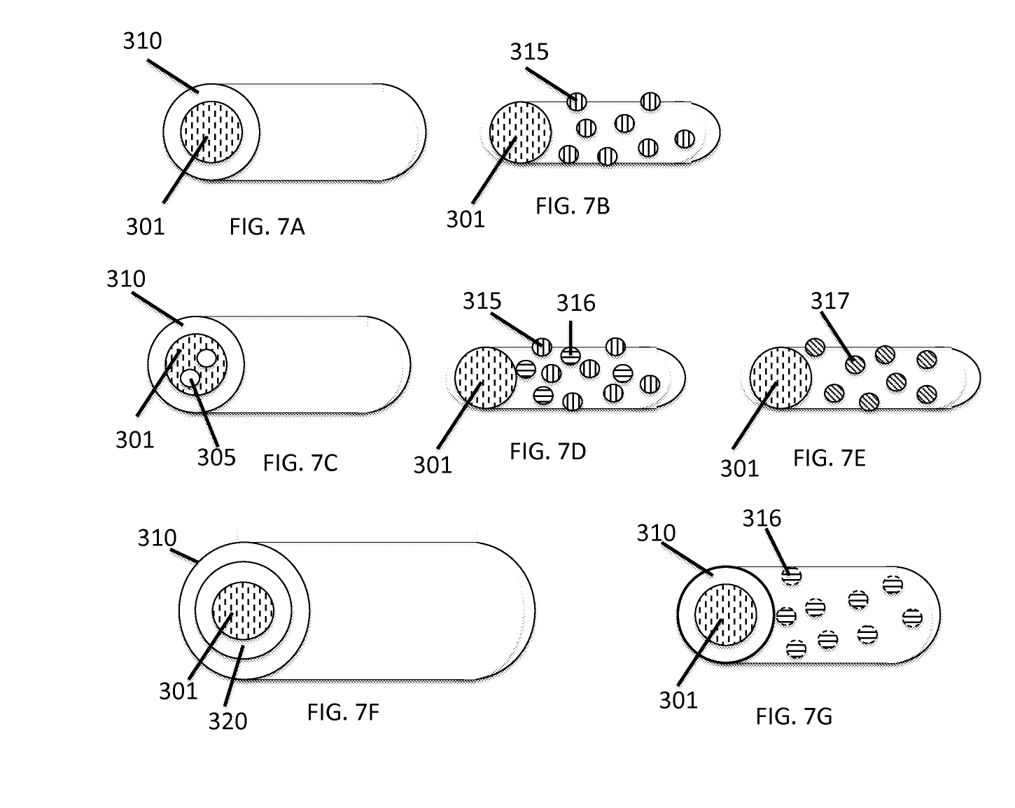

FIG. 7 is an illustration of hygroscopic material, catalyst material, or combination material formed on or within proton conducting polymer nanofibers 301. FIG. 7A is an illustration of a hygroscopic material film 310 on the surface of a proton conducting polymer nanofiber 301. FIG. 7B is an illustration of hygroscopic material nanostructures 315 on the surface of proton conducting polymer nanofibers 301. FIG. 7C is an illustration of a hygroscopic material film on the surface of proton conducting polymer nanofiber 301 having inorganic nanostructures 305 within the proton conducting polymer nanofiber 301. FIG. 7D is an illustration of hygroscopic material nanostructures and catalyst material nanostructures on the surface of a proton conducting polymer nanofiber 301. FIG. 7E is illustration of combination material nanostructures 317 on the surface of the polymer nanofiber 301. FIG. 7F is an illustration of a catalyst material film 320 on the surface of a proton conducting polymer nanofiber 301 and a hygroscopic material film 310 on the surface of the catalyst material. FIG. 3G is an illustration of catalystic material nanostructures 316 on the surface of the proton conducting polymer nanofiber 101 and hygroscopic material film on the surface on the surface of the catalyst material nanostructures 316 and also on the surface of the proton conducting polymer nanofiber 301.

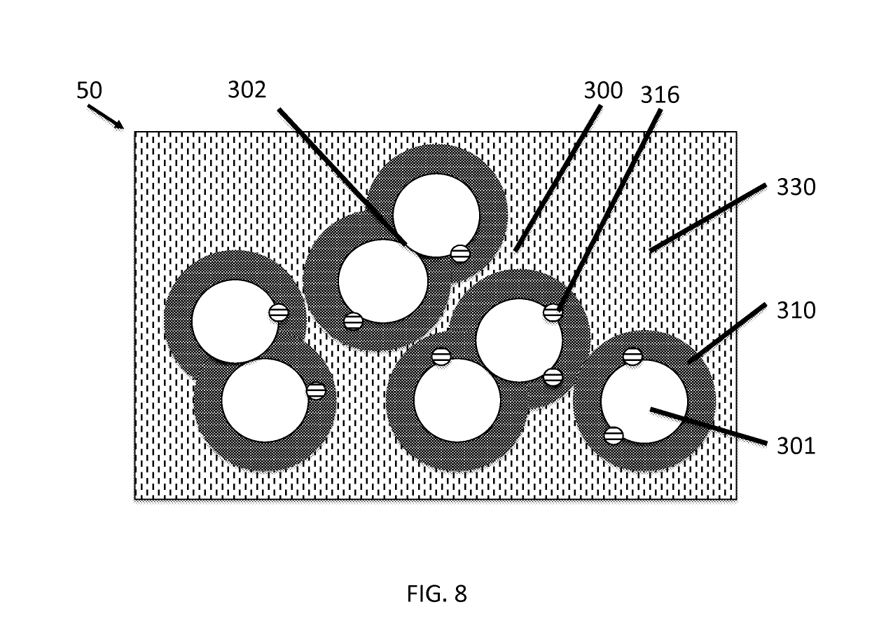

FIG. 8 is illustration of an electrolyte membrane 50 with supporting polymer 320 impregnated into nanofiber mat 300 with hygroscopic material film 310 on the surface of the proton conducting polymer nanofiber 301. The proton conducting polymer nanofibers 301 can overlap at nanofiber to nanofiber insecting region 302. Additional process steps that can optionally be performed on the nanofiber mat are annealing the proton conducting polymer nanofiber mat during which time intersecting nanofibers are bonded to one another at cross points or overlaps 302. The bonding at the intersection allows proton transport from one nanofiber to a connected nanofiber. Additional optional process step include the process of mechanically compacting the proton conducting polymer nanofiber mats to increase the volume density of nanofibers. FIG. 8 shows a catalyst material nanostructures 316 can be formed on the surface of the proton conducting polymer nanofibers. A catalyst material film, either continuous or discontinuous, can be formed on the surface of the proton conducting polymer nanofiber 301. FIG. 8 is shows a hygroscopic material film 310 deposited on both the surface of the catalyst material nanostructure and on the surface of the proton conducting polymer nanofiber. The second support polymer 330 is impregnated into the proton conducting polymer nanofiber mat 300, filling the voids in the proton conducting polymer nanofiber mat 300. Techniques that can be used to impregnate the nanofiber mat 100 with a proton conducting polymer include spray coating one surface of the nanofiber mat with a conducting polymer and pull a vacuum from the second side of the nanofiber mat, bar coating, brush coating, and the like. The second support polymer can comprise copolymers, blends, and mixtures. The second support polymer 330 may have proton conducting characteristics. Some of the functions that the second support polymer 330 can provide include but are not limited provide mechanical support, provide a barrier to crossover diffusion of H2 and O2 molecules, providing proton conduction. The second support polymer 330 can include but not be limited to polyphenylsulfone (PPSU), polyacrylonitrile (PAN) polymer, polyvinylidene difluoride (PVDF), polyether sulfone (PES), polyphenylene oxide (PPO), polyphenylene ether sulfone (PPES), polyether ketone (PEK), polyether ether ketone (PEEK), polyetherimide (PEI), polybenzimidazole (PBI), polybenzimidazole oxide (PBIO), as well as blends and combinations of these polymers.

The hygroscopic material film on the surface of the proton conducting polymer nanofiber can provide the functions of storing water molecules within the hygroscopic material film for self-humidifying the proton conducting polymer nanofiber, maintaining water molecules near the proton conducting polymer nanofibers for high operating temperatures, providing the function of reducing the water swelling of the proton conducting polymer nanofiber, providing mechanical strength to the proton conducting polymer nanofiber mat 300.

The proton conducting polymer nanofiber 301 material can include but not be limited to sulfonated poly (arylene ether sulfone) (sPAES), sulfonated polyhedral olgomeric silsesquioxane (sPOSS), perfluorosulfonic acid (PFSA), sulfonated polybenzimidazoles, sulfonated polyetheretherketone (SPEEK), sulfonated poly (fluorenyl ether ketone) (SPFEK), and copolymers, blends, and mixtures thereof.

A typical proton conducting polymer that may be formed into a proton conducting polymer nanofiber of the present disclosure include but are not limited sulfonated versions of sulfonated polybenzimidazoles, polytetrafluoroethylene (PTFE), polyvinylidene fluoride (PVDF), polyetheretherketone (PEEK), sulfonated polyetheretherketone (SPEEK), sulfonated polystyrene (PS), sulfonated polysulfone (SPSU), sulfoalkylated polysulfones, polyethersulfone (PES), perfluoroalkoxy (PFA), fluorinated ethylene propylene (FEP), polybenzimidazole, sulfonated polyimides polyimide (PI), polyamide-imide (PAI), poly(phenylene oxide), polystyrene sulfonic acid (PSSA), polyvinylsulfonic acid (PVS), polyacrylic acid (PAA), Nafion®, and copolymers and mixtures thereof. The proton conducting polymer nanofiber preferably has a glass transition point (Tg) in the range from about 100° C. to about 350° C., preferably in the range of 150° C. to about 350° C.

There are other proton conducting polymers that can be formed into nanofibers using the technique of electrospinning that are known to those skilled in the art.

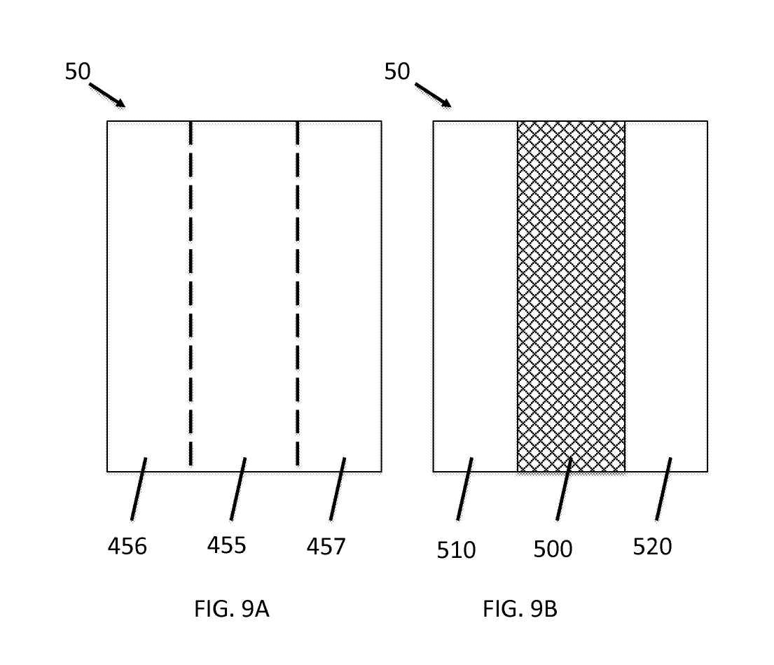

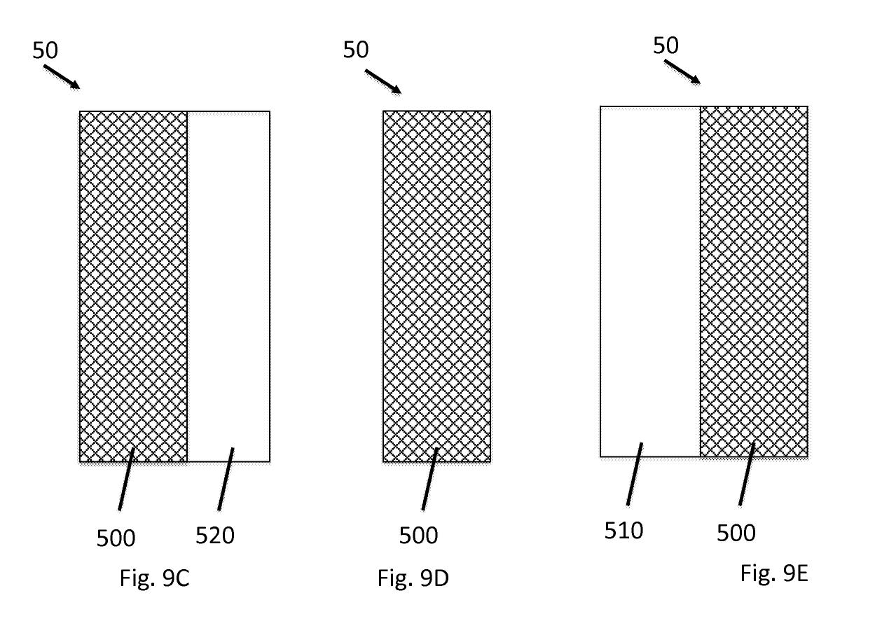

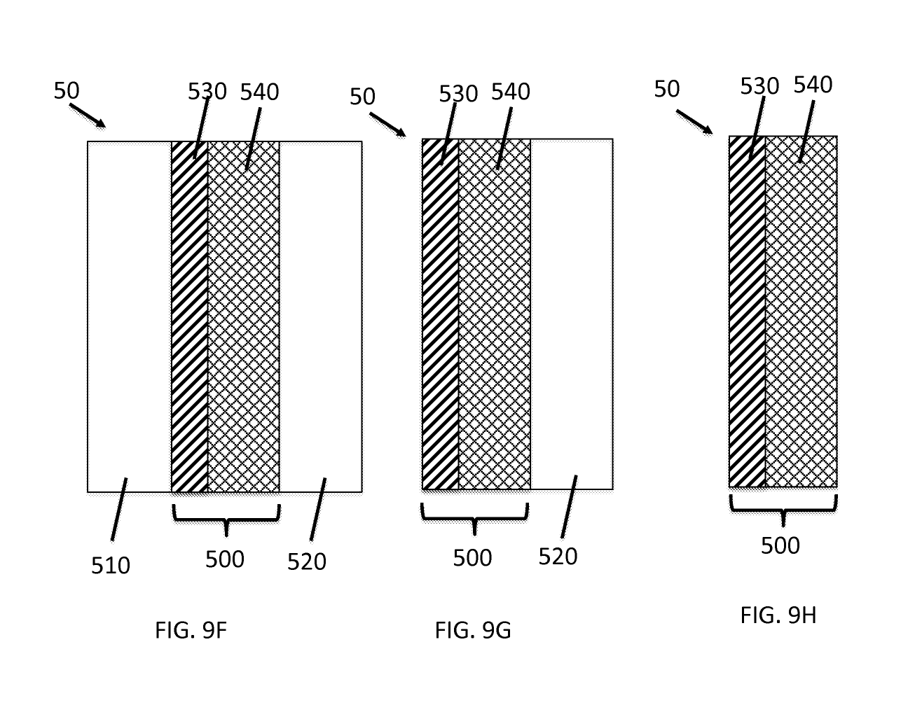

FIG. 9A is an illustration of an electrolyte membrane with an anode side region 456, a central region 455, and a cathode side region 457.

FIG. 9B is an illustration of an electrolyte membrane with central region 500 with second support polymer 530 impregnated into the voids in proton conducting polymer nanofiber mat 300, and a cathode side proton conducting polymer 520. The proton conducting polymer nanofibers may have hygroscopic characteristics, optionally have catalyst material with catalyst characteristics, and optionally have combined material with hygroscopic characteristics and catalyst characteristics. The anode side proton conducting polymer 510 and may have hygroscopic material nanostructures dispersed within the proton conducting polymer 510 with uniform or nonuniform concentration profile of the hygroscopic material nanostructures. The cathode side proton conducting polymer 520 may have hygroscopic material nanostructures dispersed within the proton conducting polymer 520 with uniform or nonuniform concentration profile of the hygroscopic material nanostructures. It is typically preferred that the region of the anode side proton conducting polymer 510 have a higher concentration of hygroscopic material nanostructure near the anode side surface because of the dehydration that occurs near the anode side under high current. The anode side proton conducting polymer 510 may have hygroscopic material nanostructures and catalyst material nanostructures dispersed within the proton conducting polymer 510 with uniform or nonuniform concentration profile. The cathode side proton conducting polymer 520 may have hygroscopic material nanostructures and catalyst material nanostructures dispersed within the proton conducting polymer 520 with uniform or nonuniform concentration profile. The anode side proton conducting polymer 510 may have combination material nanostructures dispersed within the proton conducting polymer 510 with uniform or nonuniform concentration profile. The cathode side proton conducting polymer 520 may have combination material nanostructures dispersed within the proton conducting polymer 520 with uniform or nonuniform concentration profile.

FIG. 9C is an illustration of an electrolyte membrane with central region 500 with second support polymer 530 impregnated into the voids in proton conducting polymer nanofiber mat 300, and a cathode side proton conducting polymer 520. The proton conducting polymer nanofibers may have hygroscopic characteristics, optionally have catalyst material with catalyst characteristics, and optionally have combined material with hygroscopic characteristics and catalyst characteristics. The embodiment shown in FIG. 9C can be implemented by coating a central region 500 with cathode side proton conducting polymer 520. Alternately, the embodiment shown in FIG. 9C can be implemented by removing the anode side conducting polymer 510 using techniques that may include lapping, grinding, polishing, and combinations thereof. It can be desirable tht catode side proton conducting polymer has substantially electrical nonconductive characteristics if the material in the central region 500 has electrical conductive characteristics.

FIG. 9D is an illustration of an electrolyte membrane with central region 500 with second support polymer 530 impregnated into the voids in proton conducting polymer nanofiber mat 300, and a cathode side proton conducting polymer 520. The proton conducting polymer nanofibers may have hygroscopic characteristics, optionally have catalyst material with catalyst characteristics, and optionally have combined material with hygroscopic characteristics and catalyst characteristics. The embodiment shown in FIG. 9D can be implemented by removing the anode side proton conducting polymer 510 and the cathode side proton conducting polymer using techniques that may include lapping, grinding, polishing, and combinations thereof.

FIG. 9E is an illustration of an electrolyte membrane with central region 500 with proton conducting polymer 330 impregnated into the voids in nanofiber mat 300, and an anode side proton conducting polymer 510. The proton conducting polymer nanofibers 301 may have hygroscopic characteristics, optionally have catalyst material with catalyst characteristics, and optionally have combined material with hygroscopic characteristics and catalyst characteristics. The embodiment shown in FIG. 9E can be implemented by coating a central region 500 with proton conducting polymer 510. Alternately, the embodiment shown in FIG. 9E can be implemented by removing the cathode side conducting polymer 520 of the embodiment shown in FIG. 5B using techniques that may include lapping, grinding, polishing, and combinations thereof. It can be desirable that the anode side proton conducting polymer has substantially electrical nonconductive characteristics if the material in the central region 200 has electrical conductive characteristics.

FIG. 9F is an illustration of an electrolyte membrane with anode side proton conducting polymer 510; a central region 500 with proton conducting polymer 330 impregnated into the voids in nanofiber mat 300 with the nanofibers having nonuniform concentration profile of material having hygroscopic characteristics, optionally having catalyst material with catalyst characteristics, and optionally having combined material characteristics; and a cathode side proton conducting polymer 520. The concentration of the hygroscopic material on or within the nanofiber mat will typically be higher near the side of the nanofiber mat in the central region 500 near the anode 530 then the region of the fiber mat in the central region closer to the cathode 540. The concentration of hygroscopic material may have a monotonic decreasing concentration from the anode side of the fiber mat to the cathode side of the fiber mat, may have a step concentration profile with typically a higher concentration near the anode side of the fiber mat, or may have other concentration profiles. The catalyst material may have nonuniform concentration profile and the combined material may have nonuniform concentration profile. The hygroscopic material and catalyst material may have different concentration profiles.

FIG. 9G is an illustration of an electrolyte membrane with a central region 500 with proton conducting polymer 330 impregnated into the voids in nanofiber mat 300 with the nanofibers having nonuniform concentration profile of material having hygroscopic characteristics, optionally having catalyst material with catalyst characteristics, and optionally having combined material characteristics; and a cathode side proton conducting polymer 520. The embodiment in FIG. 9G is similar to the embodiment in FIG. 9F with the anode side proton conducting polymer 510 removed.

FIG. 9H is an illustration of an electrolyte membrane with a central region 500 with proton conducting polymer 530 impregnated into the voids in nanofiber mat 300 with the nanofibers having nonuniform concentration profile of material having hygroscopic characteristics, optionally having catalyst material with catalyst characteristics, and optionally having combined material characteristics; and a cathode side proton conducting polymer 520. The embodiment in FIG. 9G is similar to the embodiment in FIG. 9F without the anode side proton conducting 510 polymer and the cathode side proton conducting polymer 520.

Example Process: Outline of process steps to fabricate electrolyte membrane with proton conducting polymer impregnated into reinforcing nanofiber mat optionally having hygroscopic characteristics, optionally having catalyst characteristics, and optionally having combination material characteristics

1. Optionally form a polymer mixture by mixing or blending.

2. Optionally mix inorganic hygroscopic material nanostructures, inorganic catalyst material nanostructures, inorganic combined material nanostructures, inorganic proton conducting nanostructures, inorganic nanostructures with proton conducting and hygroscopic characteristic into a polymer.

3. Form electrospun reinforcing nanofiber mat optionally incorporating inorganic material nanostructures.

4. Optionally anneal to convert the polymer nanofiber to a carbon nanofiber or an inorganic metal oxide nanostructure.

5. Optionally anneal to the polymer reinforcing nanofiber mat during which time intersecting nanofibers are bonded to one another at cross points or overlaps.

6. Optionally mechanically compact the reinforcing nanofiber mats to increase the volume density of nanofibers.

7. Optionally activate/functionalize the surface of nanofiber to improve the nucleation or adhesion of hygroscopic material, catalysts material, or combination material on the nanofiber surface.

8. Optionally deposit combination material nanostructures on the surface of the nanofiber, in pores in the nanofiber, and on the exposed surface of inorganic nanostructures within the nanofibers. Optionally deposit a combination material as an atomic layer deposited laminate material having layers of hygroscopic material and catalyst material. An example of a atomic layer deposited combination material is a laminate formed of one or more alternating pairs of silicon oxide film and platinum film. Optionally deposit the combination material with a nonuniform concentration profile on the reinforcing re mat. Techniques to deposit the combination material with a nonuniform concentration profile in the reinforcing nanofiber mat include atomic layer deposition with ALD precursor exposure from one side of the reinforcing nanofiber mat, spray coating one side of the nanofiber mat with combination material nanostructures, partically dipping the nanofiber mat in a solution having combination material nanostructures, and other techniques known to those of ordinary skill in the art.

9. Coat the polymer nanofiber or the inorganic nanofiber with hygroscopic material. The hygroscopic material may be a hygroscopic material film deposited on the surface of the nanofiber, in pores in the nanofiber, and on the exposed surface of inorganic nanostructures within the nanofibers using atomic layer deposition or molecular vapor deposition. The hygroscopic material can be non-vapor formed hygroscopic material nanostructures deposited on the surface of the nanofibers using electrochemical growth of nanoparticles, hydrothermal growth of nanoparticles, fluid immersion, aerosol spraying of nanoparticles, vacuum sraying of nanoparticles, aerosol vacuum spraying of nanoparticles, and combinations thereof. Optionally deposit the hygroscopic material with a nonuniform concentration profile in the reinforcing nanofiber mat. Techniques to deposit the hygroscopic material with a nonuniform concentration profile in the nanofiber mat include atomic layer deposition with ALD precursor exposure from one side of the nanofiber mat, spray coating one side of the nanofiber ma with hygroscopic material nanostructures, partically dipping the nanofiber mat in a solution having hygroscopic material nanostructures, and other techniques known to those of ordinary skill in the art.

10. Optionally coat the hygroscopic material on the polymer nanofiber or the inorganic nanofiber with catalyst material. The catalyst material may be a catalyst material film deposited on the surface of the nanofiber and hygroscopic material, in pores in the nanofiber, and on the exposed surface of inorganic nanostructures within the nanofibers using atomic layer deposition or molecular vapor deposition. The catalyst material can be non-vapor formed hygroscopic material nanostructures deposited on the surface of the nanofibers using electrochemical growth of nanoparticles, hydrothermal growth of nanoparticles, fluid immersion, aerosol spraying of nanoparticles, vacuum sraying of nanoparticles, aerosol vacuum spraying of nanoparticles, and combinations thereof. Optionally deposit the catalyst material with a nonuniform concentration profile in the nanofiber mat. Techniques to deposit the catalyst material with a nonuniform concentration profile in the nanofiber mat include atomic layer deposition with ALD precursor exposure from one side of the nanofiber mat, spray coating one side of the nanofiber ma with hygroscopic material nanostructures, partically dipping the nanofiber mat in a solution having hygroscopic material nanostructures, and other techniques known to those of ordinary skill in the art.

11. Impregnate the reinforcing nanofiber mat with proton conducting polymer. Techniques that can be used to impregnate the nanofiber mat 100 with a proton conducting polymer include spray coating one surface of the nanofiber mat with a conducting polymer and pull a vacuum from the second side of the nanofiber mat, bar coating, brush coating, and the like.

12. Optionally coat the anode side of the central region having a reinforcing nanofiber mat with an anodes side proton conducting polymer

13. Optionally coat the cathode side of the central region having a reinforcing nanofiber mat with an cathode side proton conducting polymer

14. Optionally remove the anode side proton conducting polymer and optionally a portion of the central region having a reinforcing nanofiber mat using techniques that may include lapping, grinding, polishing, and combinations thereof.

15. Optionally remove the cathode side proton conducting polymer and optionally a portion of the central region having a reinforcing nanofiber mat using techniques that may include lapping, grinding, polishing, and combinations thereof.

16. Adhere or press the anode backing layer/anode catalyst layer and the cathode backing layer/catalyst layers onto the primary surface of the electrolyte membrane to form a membrane electrode assembly.

Example Process: Outline of process steps to fabricate electrolyte membrane with proton conducting polymer nanofiber mat impregnated with second support polymer

1. Optionally form a polymer mixture by mixing or blending comprising a proton conducting polymer

2. Optionally mix inorganic hygroscopic material nanostructures, inorganic catalyst material nanostructures, inorganic combined material nanostructures, inorganic proton conducting nanostructures, inorganic nanostructures with proton conducting and hygroscopic characteristics into the polymer or polymer blend comprising a proton conducting polymer.

3. Form electrospun proton conducting polymer nanofiber mat optionally incorporating inorganic nanostructures.

4. Optionally anneal to the proton conducting polymer nanofiber mat during which time intersecting nanofibers are bonded to one another at cross points or overlaps. The bonded regions may allow proton transport form one proton conducting polymer nanofiber to an adjacent proton conducting polymer nanofiber.

5. Optionally mechanically compact the proton conducting polymer nanofiber mats to increase the volume density of proton conducting polymer nanofibers.

6. Optionally activate/functionalize the surface of proton conducting polymer nanofiber to improve the nucleation or adhesion of hygroscopic material, catalysts material, or combination material.

7. Optionally deposit combination material nanostructures on the surface of the proton conducting polymer nanofiber, in pores in the nanofiber, and on the exposed surface of inorganic nanostructures within the nanofibers. Optionally deposit the combination material with a nonuniform concentration profile of combination material nanostructures within the proton conducting nanofiber mat. Optionally deposit a combination material as an atomic layer deposited laminate material having layers of hygroscopic material and catalyst material. An example of a atomic layer deposited combination material is a laminate formed of one or more alternating pairs of silicon oxide film and platinum film. Optionally deposit the combination material with a nonuniform concentration profile in the nanofiber mat. Techniques to deposit the combination material with a nonuniform concentration profile in the proton conducting polymer nanofiber mat include atomic layer deposition with ALD precursor exposure from one side of the nanofiber mat, spray coating one side of the nanofiber mat with combination material nanostructures, partically dipping the nanofiber mat in a solution having combination material nanostructures, and other techniques known to those of ordinary skill in the art.

8. Coat the proton conducting polymer with hygroscopic material. The hygroscopic material may be a hygroscopic material film deposited on the surface of the nanofiber, in pores in the nanofiber, and on the exposed surface of inorganic nanostructures within the proton conducting polymer nanofibers using atomic layer deposition or molecular vapor deposition. The hygroscopic material can be non-vapor formed hygroscopic material nanostructures deposited on the surface of the proton conducting polymer nanofibers using electrochemical growth of nanoparticles, hydrothermal growth of nanoparticles, fluid immersion, aerosol spraying of nanoparticles, vacuum sraying of nanoparticles, aerosol vacuum spraying of nanoparticles, and combinations thereof. Optionally deposit the hygroscopic material with a nonuniform concentration profile in the proton conducting polymer nanofiber mat. Techniques to deposit the hygroscopic material with a nonuniform concentration profile in the nanofiber mat include atomic layer deposition with ALD precursor exposure from one side of the proton conducting polymer nanofiber mat, spray coating one side of the nanofiber mat with hygroscopic material nanostructures, partically dipping the nanofiber mat in a solution having hygroscopic material nanostructures, and other techniques known to those of ordinary skill in the art.

9. Optionally sulfonate the hygroscopic material and the surface of the nanofiber. Techniques for sulfonating the hygroscopic material, catalyst material, nanofiber surface, pore surfaces, and nanoparticles within the nanofiber include but are not limited to soaking in a solutions having concentrated H2SO4 with a concentration of about 98 percent at 80 C for about a hour, exposure to fuming sulfuric acid, soaking in chlorosulfonic acid, and combinations thereof.

10. Optionally coat the hygroscopic material on the proton conducting polymer nanofiber with catalyst material. The catalyst material may be a catalyst material film deposited on the surface of the nanofiber and hygroscopic material, in pores in the nanofiber, and on the exposed surface of inorganic nanostructures within the nanofibers using atomic layer deposition or molecular vapor deposition. The catalyst material can be non-vapor formed hygroscopic material nanostructures deposited on the surface of the nanofibers using electrochemical growth of nanoparticles, hydrothermal growth of nanoparticles, fluid immersion, aerosol spraying of nanoparticles, vacuum sraying of nanoparticles, aerosol vacuum spraying of nanoparticles, and combinations thereof. Optionally deposit the catalyst material with a nonuniform concentration profile in the nanofiber mat. Techniques to deposit the catalyst material with a nonuniform concentration profile in the nanofiber mat include atomic layer deposition with ALD precursor exposure from one side of the nanofiber mat, spray coating one side of the nanofiber ma with hygroscopic material nanostructures, partically dipping the nanofiber mat in a solution having hygroscopic material nanostructures, and other techniques known to those of ordinary skill in the art.

11. Optionally sulfonate the hygroscopic material and the surface of the nanofiber. Techniques for sulfonating the hygroscopic material, catalyst material, nanofiber surface, pore surfaces, and nanoparticles within the nanofiber include but are not limited to soaking in a solutions having concentrated H2SO4 with a concentration of about 98 percent at 80 C for about a hour, exposure to fuming sulfuric acid, soaking in chlorosulfonic acid, and combinations thereof.

12. Impregnate the proton conducting nanofiber mat with a second support polymer. Techniques that can be used to impregnate the proton conduction polymer nanofiber mat 300 with a second support polymer include spray coating one surface of the nanofiber mat with a second support polymer will exposing the proton conducting nanofiber mat to a vacuum from the second side of the nanofiber mat, bar coating, brush coating, and the like.

13. Optionally coat the anode side of the central region having a proton conducting polymer nanofiber mat with an anodes side proton conducting polymer.

14. Optionally coat the cathode side of the central region having a proton conducting nanofiber mat with a cathode side proton conducting polymer.

15. Optionally remove the anode side proton conducting polymer and optionally a portion of the central region having a proton conducting polymer nanofiber mat using techniques that may include lapping, grinding, polishing, and the like, and combinations thereof.

16. Optionally remove the cathode side proton conducting polymer and optionally a portion of the central region having a proton conducting polymer nanofiber mat using techniques that may include lapping, grinding, polishing, and combinations thereof.

17. Adhere or press the anode backing layer/anode catalyst layer and the cathode backing layer/catalyst layers onto the primary surface of the electrolyte membrane to form a membrane electrode assembly.

Obviously many modifications and variations of the present invention are possible in light of the above teachings. It is therefore to be understood that the claimed invention may be practiced otherwise than as specifically described. Any reference to claim elements in the singular, e.g., using the articles “a,” “an,” “the,” or “said” is not construed as limiting the element to the singular.

Although particular embodiments, aspects, and features have been described and illustrated, it should be noted that the invention described herein is not limited to only those embodiments, aspects, and features, and it should be readily appreciated that modifications may be made by persons skilled in the art. The present application contemplates any and all modifications within the spirit and scope of the underlying invention described and claimed herein, and all such embodiments are within the scope and spirit of the present disclosure.

What is claimed is:

1. A proton exchange membrane with self-humidifying characteristics, comprising:
a first material comprising nanofibers wherein the nanofibers have hygroscopic characteristics; and
a second material comprising a proton conducting polymer that is impregnated into voids between the nanofibers to form a proton exchange membrane;
wherein the proton exchange membrane is self-humidifying.
